(19) United States
(12) Patent Application Publication
(10) Pub. No.: US 2005/0088632 A1
(43) Pub. Date: Apr. 28, 2005

(54) Vitasolve dissolving film strips with supplements pharmaceutical drug(RX), +vitamins

(76) Inventors: Sonja Jo Sadi, Burbank, CA (US); Jeanette Marie Jogiel, Sacramento, CA (US)

Correspondence Address: JEANETTE JOGIEL, 1200 S Street, Sacramento, CA, 95814, US

(21) Appl. No.: 10/894,486

(22) Filed: Jul. 20, 2004

Related U.S. Application Data
(60) Provisional application No. 60/488,647, filed on Jul. 21, 2003.

(51) Int. Cl. G03B 27/52; G03B 27/00

(52) U.S. Cl. 355/1

(57) ABSTRACT

The present invention relates to the preparation of a film strip compound which melts in the mouth instantly and provides a suitable drug delivery for people who can not swallow tablets. The film strip of the invention compounds melt at or below body temperature. They are fragile, yet offer stability until released and generally comprise of few insoluble disintegrants which may cause a gritty or chalky sensation in the mouth.

Vitasolve instant dissolving film strip is for the oral delivery of a broad range of ingredients such as supplements, food supplements and pharmaceuticals.

### BACKGROUND OF THE INVENTION

There are no currently no other products to our knowledge of this process and our descriptions and claims. We thought of the idea as our friend could not take pills.

### BRIEF SUMMARY OF THE INVENTION

Vitasolve instant dissolving film strips for the oral delivery of various active and non active ingredients such as supplements, homeopathy, and pharmaceuticals for human and animal use.

### DRAWING OF THE INVENTION

The current inventions drawing shows a rectangle shape that is ¾×1 ½ and is 0.10 to 0.30 mg thick which is the current design but not limited to this size.

### DETAILED DESCRIPTION OF THE INVENTION

The current invention is for a fast dissolving film strip formulated with supplements, pharmaceuticals, and vitamins. The film strip dissolves and melts instantly when placed in the mouth.

Made with binding the ingredients and then formed by sheeting the film strip into little mouth size film strips that are comfortable for the mouth of the user. The current invention offers a binder with active ingredients in the film strip which dissolves in seconds compared to other solid dosage forms as pill or tablets. The fast dissolving/melting film strip has at least one compound which partially or fully melts at or below body temperature.

The film strips of the invention may also include at least one active ingredient and may also include one or more discontegrients, flavors, colorants, and sweeteners.

The hardness of the film strip is very low. The film strip has low friability and it will dissolve and melt instantly when placed in the mouth.

Attributes such as 1) fast film strip dissolution 2) feels good in the mouth 3) film strip physical stability are of greater importance than minimum and maximum values of film strip hardness. Nevertheless the film strip is very pliable and has a very low friability. The film strip has an excellent mouth tongue feel resulting from the low melting point components which melts on the tongue or under the tongue or on the inner cheek of the mouth.

The term film strip refers to a supplement, homeopathic, vitamin, or pharmacological composition in the form of a small, essentially thin, semi opaque or opaque film strip of any size or shape. The film strip shapes are not limited to rectangular, round, irregular and square.

Additionally, other substances commonly used in supplement, homeopathy, vitamin, or pharmaceutical formulations can be included such as and not limited to flavors (i.e. peppermint, orange, pineapple, cherry apple, fruit extracts, flavor enhancers and sweeteners (i.e. sorbitol, glucose, sucrose, souring agents (i.e. lemon), dyes, or colorants).

The film strip may also include any method of forming a film strip of the invention into a desired shape.

A preferred method of forming the film strip compositions of the invention including mixing a fast dissolving disintegrant(s) and active ingredient(s)

Compressed film strips are solid dosage forms prepared by compacting a formulation containing an active ingredient and excipients selected to aid the processing and improve the properties of the product. The term “compressed film strip” generally refers to a plain, uncoated film strip for oral ingestion, prepared by a single compression or by pre-compaction tapping followed by a final compression. Such pre-compaction tapping does not necessarily overcome the flow and die fill problems associated with the use of very fine particles prior to the final compression of the film strips.

Film strips can be made in many sizes and shapes, with a variety of properties. Film strips are a new concept and are not used in pharmaceutical, supplement or herbal dosage forms. The film strip is far more convenient, easy to use, and less expensive to manufacture than other oral dosage forms. They deliver the intended dose with accuracy. There are comparisons of tablets or pill form that are widely used as they are a form of ingesting pharmaceuticals, supplements and or herbals. Other common forms are liquids. The uniqueness of this invention is desired by all and especially those who do not like taking pills nor can ingest pills.

Convenient and economically feasible processes by which the film strip of the invention may be produced are also provided. Ingredients are boiled, dried, rolled out and punched and then packaged. After punching, the curve of film strip should be in limited range, the film strips should be in lines and without any coherence. The film strips should be 24 layers and then the operation technology is to test the pressure first, then confirm the parallel between cutting knife and cutting base before working.

Clean the left after each punching process to guarantee the two are equal. Then, to slowly remove the film strip after punching. Clean machine thoroughly after each use and oil turning parts of the machine one time per month at least. Putting hands into punching area is prohibited during operation or stopping the machine for any problem.

Colloid grinding machine operations of the film strip is a clean process. Putting hands into material inlet is prohibited and stopping the machine for any problem. Closing the material outlet during operation prohibited in case high pressure in cavity of the machine leads to leakage. To adjust the grinding blade's gap and lock the adjust ring after finishing while checking electrical. To feed any hard thing mixing with material during operation prohibited. To clean cavity of the machine after working and not to leave any left inside avoiding coherence. To release graduated disc after working. To clean with soft cloth, then dry it with dry cloth. Striping machine production standards are for product awareness. The thickness of big film strips is 4 dmm and 0.2 more or less. Front side of the big film strip is bright and back side is smooth without bubbles and water-stream trace. No curling, broken while extend the big stripe. To keep the big film stripe with no wrinkling, flatling, equal pulling force at two sides etc in rolling production. To lighted the finished products bag and send it to appointed site. Striping machine operation involves total attention of the operator. Also, to clean around field and machine before operation. To pay much attention to all possibilities during operation and feeding.

To make wrinkle and broken free film strips, help is required in rolling with hands to keep the roll and copper-board in one speed while the roll becoming bigger. To adjust materials well before feeding. To stop the machine for any problem. To confirm all tools and clean around field and machine. To throughy clean the machine twice per week and take all things that are left and wash. Then, check and clean air-blower in time.

Marking Machine production standard and Operation technology To keep printing side clear and confirm date. To keep gluing-head and printing-board clean during operation. To scrape ink with care. To oil turn parts of the machine one time per month at least. To clean printing side before adjusting date. To stop the machine for any problem and to clean the machine after working.

Packing Machine Standard Well-shaped, smooth base and no leakage. Aluminum foil without wrinkle and press traced after hot-pressing. Net mark should be clear and aluminum foil is in good coherence. The size of products should match packing.

When packing keep the machine clean and tools in their position before operation. To protect the IC system of the machine, pre-hot the machine to 100 degree, then operate it. To run it and confirm pressure and punching before feeding. To check the punched products in time. To confirm the hot-deal closed in its position after the machine turn-off. To oil turn parts one time per day. To clean the machine with soft cloth after work.

Safe and sanitation inspector responsibilities include to have basic knowledge of IC system, mechanical machine, steam pressure etc. To correct mis-operation and mis-clothing. To use different inspection including regular and irregular to keep the entire factory clean.

Bacteria-free production involves use Frequency-conversion Ozone Generator two time in ruled time everyday (AM:4:00-4:40,PM:11:00-11:40) and 40 minutes every time and test.

Binding ingredients are as follows: corn starch, sodium alginate, maltose, partially dementholized sorbitol, cellulose, aspartame, glycerin fatty acid esters, natural edible color.

The active ingredients are vitamins, herbs, pharmaceuticals and supplements below:

1) Vitamin A, 2) Vitamin B1, B2, B6, B12, 3) Niacin amide, 4) antithetic acid, 5) biotin, 6) folic acid, 7) inositol, 8) cholin, 9) paba, 10) vitamin e, 11) Vitamin C 12) Vitamin D 13) alfalfa, 14) aloe vera, 15) blessed thistle, 16) burdock root, 17) capsicum, 18) cascara sagrada, 19) chamomile, 20) chaparral, 21) comfrey, 22) echinacea, 23) euphrasy, 24) garlic, 25) ginger, 26) ginseng, 27) hawthorne berries, 28) hyssop, 29) licorice, 30) Peruvian Ginseng 31) mullein, 32) rose hips, 33) sarsaparilla, 34) spiraling, 35) yellow dock, 36) Basil, 37) Bay, 38) Caraway, 39) Chervil, 40) Chives, 41) Cilantro 42) Dill 43) Fennel 44) 45) French Sorrel 46) Garlic 47) Horse Radish 48) Lemon Balm 49) Lemon Thyme, 50) Lovage, 51) Marjoram, 52) Mints, 53) Oregano, 54) Parsley, 55) Rosemary, 56) Sage, 57) Salad Burnett, 58) Savory, 59) Sweet Cicely, 60) Tarragon, 61) Thyme, 62) Basil, 63) Borage, 64) Calendula, 65) Chamomile, 66) Onion, 67) Cabbage, 68) Dill, 69) Raspberries, 70) Mint, 71) Parsley, 72) Sage, 73) Bay laurel, 74) Cuban Oregano, 75) Lemon 76) Eucalyptus, 77) Lemon Verbena, 78) Tarragon, 79) Pineapple, 80) Stevia; 81) Rosemary, 82) Borage 83) Honeysuckle, 84) Anise, 85) Hyssop 86) Angelica, 87) Cinnamon, 88) Catnip 89) Marshmallow, 90) Motherwort, 91) Mugwort, 92) Pennyroyal, 93) Skullcap, 94) St. John's Wort, 95) Valerian, 96) green tea and extracts of green tea, 97) bilberry, 98) black cohosh 99) black walnut, 100) blessed thistle, 101) charcoal, 102) dong quai, 103) eyebright, 104) chickweed, 105 ) golden seal, 106) guggul lipid, 107) hydranea, 108) juniper berries, 109) kelp, 110) passion flower, 111) pau d'arco 112) red clover, 113) saw palmetto, 114) slippery elm, 115) safflowers, 116) uva ursi, 117) yucca, 118) calcium, 120) magnesium 121) amino acids, 122) Rhus tox, 123) Bryonia, 124) Kali lod, 125) Merc sol, 126) Medorrhinum, 127) Viscum alb, 128) Crateagus, 129) Rauwolfia, 130) Lachesis, 132) Nat mur, 133) Verat alb, 134) Ana barb, 135) Ars alb, 136) Echinacea, 137) Gels, 138) Ferrum phos, 139) Eupatorium perf, 140) Colocynthis, 141) Alumina, 142) Bryonia, 143) Lachesis, 144) Lycopodium, 145) Merc cor, 146) Nux vom, 147) Plumbum acet, 148) Sulphur, 149) Alumen, 150) Causticum, 151) Sepia, 152) Nux vom, 153) Acid phos, 154) Baptisia, 155) Chamomilla, 156) Chin off, 157) Colocynthis, 158) Ferrum phos, 159) Merc cor, 160) Oleander, 161) Rhus tox, 162) Verat alb, 163) Anacardium, 164) Arg nit 165) Ars alb, 166) Belladonna, 167) Carbo veg, 168) Chamomilla, 169) Chelidonium, 170) Lycopodium, 171) Nuc vom, 172) Scrophularia, 173) Aconite, 174) ferrum phos, 175) China off, 176) Pyrogenium 177) Arnica 178) soy, 179) Alumen, 180) Nux vom Anacardium, 181) Argnit, 182) Ars alb, 183) Carbo veg, 184) Chelidonium, 185) Lycopodium Nuc vom 186) Scrophularia Platago, 187) Avena sativa, 187) Ignatia Daphne, 188)Quercus Calendula Nux vom, 188) Potassium Guarana (seed) 189) Ginger (root) 151) Cayenne 152) Kola(aerial) 153) Dandelion (aerial) 154) Liquorice(ael&root) 155) Bladderwrack 156) Gymnema 157) Fenugreek 158) Dandelion, 159) Tansy, 160) White Willow Aconite Poke Root (root), 161) Nat Phos, 162) Mustard (seed), 163) Dandelion Licorice, 164) Caraway (seed), 165) Fennel, 166) Bisacodyl, 167). Senna 168). Loperamide 169). Pseudoephedrine HCL, 170) Dextromethorphan HBr, 171) Chlorpheniramine Maleate, 180) Clemastine Fumarate, 181) Loratadine 182) Diphenhydramine HCL, 183) Doxylamine Succinate, 184) Benzocaine, 185) Menthol, 186) Phenol, 187) Clonidine HCl, 188) Enalapril maleate, 189) Lisinopril, 190) doxazosin, 191) Terazosin HCl, 192) Nat Sulph silica, 193) nicotine. 194) cortycets PS, 195) 5-hydroxytrytothan, 196) pencillin, 197) cephalosporins, 198) griseofulvin, 199) Polymyxin B 200) Erythromycin 201) Streptomycin 202) Tetracycline 203) Vancomycin 204) Gentamicin 205) Rifamycin 206) tricyclic, 207) tetracyclic, 208) Sertraline 209) hydrochloride 210) metaxalone 211) dimethylphenoxy)methyl]-2-oxazolidinone

A formula example would be:
vitamin c, 9.00o%
corn starch, 20.00%
sodium alginate, 20.0%
maltose, 47.00%
partially dementholized sorbitol, 1.00%
cellulose, 0.30%
aspartame, 0.001%
glycerin, 0.98%
fatty acid esters, 1.20%
natural edible color, 0.00025%

1. We claim a dissolving/melting delivery system of pharmaceuticals, dietary supplements and food/herbal supplements.

2. We claim it has up to 98% absorption in the body with sublingual delivery.

3. We claim our delivery composition of a binder formulated with: corn starch, sodium alginate, maltose, partially dementholized sorbitol, cellulose, glycerin, fatty acid ester, natural editable color or modified starch, marine alga na, fibrindluey, menthol, emulsion agent, refrigerant, arsba sweetset.
